(19) United States
(12) Patent Application Publication
(10) Pub. No.: US 2008/0149365 A1
(43) Pub. Date: Jun. 26, 2008

(54) FAN HAVING WIRE SECURING MECHANISM

(75) Inventor: ZHENG-HENG SUN, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/782,653

(22) Filed: Jul. 25, 2007

(30) Foreign Application Priority Data
Dec. 21, 2006 (CN) 200610201361.8

(51) Int. Cl. H01B 7/00; H01B 17/00

(52) U.S. Cl. 174/135; 174/168

(57) ABSTRACT

A fan includes an exterior frame, a motor with an impeller disposed in the frame, a wire electrically connected with the motor and reaching out of the frame, and at least one wire securing mechanism. The at least one wire securing mechanism includes two spaced hooks formed on the frame to allow the wire winding around the hooks with a plurality of loops each encircling the hooks therein.

### CROSS-REFERENCE TO RELATED APPLICATION

Relevant subject matter is disclosed in a co-pending U.S. Patent Application filed on the same date with the present application and entitled “BLOWER HAVING WIRE HOLDING STRUCTURE”, assigned to the same assignee with this patent application.

### BACKGROUND OF THE INVENTION

1. Field of the Invention

The present invention relates to fans, and more particularly to a fan having wire securing mechanism.

2. Description of related art

A fan generally includes an exterior frame, a motor with an impeller installed inside the frame, and a wire extending out of the motor. An end of the wire is electrically connected to an external power source via a socket connector and the other end of the wire is electrically connected with a circuit board in the motor, thereby supplying power to the motor.

The fan manufacturers generally leave a very long wire in a fan to meet various applications. But in many situations, the length of the wire is longer than a distance from a place, where the fan is set, to a desired plug connector that the socket connector is plugged with, and the excess portion of the wire is loosely laid in the electrical system where the fan is disposed. If the excess wire contacts a heat-generating component in the electrical system, the wire may burn.

What is desired, therefore, is a fan which has a wire securing mechanism.

### SUMMARY OF THE INVENTION

In one embodiment, a fan includes an exterior frame, a motor with an impeller disposed in the frame, a wire electrically connected with the motor and reaching out of the frame, and at least one wire securing mechanism. The at least one wire securing mechanism includes two spaced hooks formed on the frame to allow the wire winding around the hooks with a plurality of loops each encircling the hooks therein.

Other advantages and novel features of the present invention will become more apparent from the following detailed description of preferred embodiment when taken in conjunction with the accompanying drawings, in which:

### BRIEF DESCRIPTION OF THE DRAWINGS

FIG. 1 is an isometric view of a fan in accordance with a first embodiment of the present invention, with a corner portion of the fan being cut away;

FIG. 2 is an inverted view of FIG. 1;

FIG. 3 is similar to FIG. 1, but showing an excess portion of a wire being wound on a wire securing mechanism of the fan;

FIG. 4 is an isometric view of a fan in accordance with a second embodiment of the present invention; and

FIG. 5 is an isometric view of a fan in accordance with a third embodiment of the present invention.

### DETAILED DESCRIPTION OF THE INVENTION

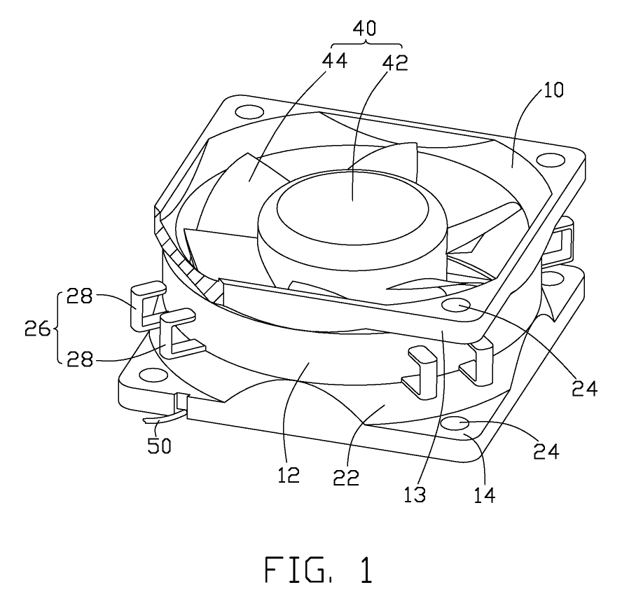

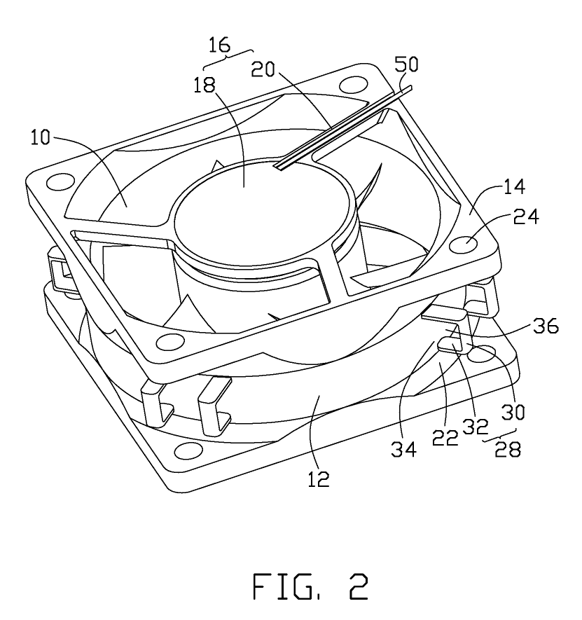

Referring to FIGS. 1 and 2, in a first embodiment of the present invention, a fan includes an exterior frame 10, a motor (not visible) with an impeller 40 installed inside the frame 10, and a wire 50 electrically connected with the motor and reaching out of the frame 10. A support structure 16 is disposed on a lower surface of the frame 10. The support structure 16 includes a circular support portion 18 situated at a center of the lower surface, and a plurality of elongated coupling portions 20 coupling the support portion 18 with a lower edge of the frame 10. The motor is secured to the support portion 18. The wire 50 reaches out of the support portion 18 and is laid along one coupling portion 20 which defines a slot for receiving the wire 50. Four first installing portions 13 and four second installing portions 14 protrude out from an upper edge and the lower edge of the frame 10, respectively. A recessed portion 22 is formed between each of the four first installing portions 14 and one opposite second installing portion 14. An installing hole 24 is defined in each of the installing portions 14 for securing the fan to a place as desired. A wire securing mechanism 26 is set in each recessed portion 22, and the wire securing mechanism 26 includes two parallel hooks 28. Each hook 28 is generally C-shaped in profile, and includes a winding portion 30 protruding from a periphery 12 of the frame 10, and a stopping portion 32 extending from a free end of the winding portion 30 and bent toward the periphery 12 of the frame 10. The winding portion 30 takes the form of an “L”. A gap 34 is defined between the periphery 12 of the frame 10 and a free end of the stopping portion 32. A width of the gap 34 is appreciably smaller than a diameter of the wire 50. Each hook 28 and the periphery 12 of the frame 10 cooperatively define a receiving space 36. The wire 50 is to be placed in the two receiving spaces 36 through the corresponding gaps 34.

The impeller 40 includes a circular hub 42 rotatably secured to the motor and a plurality of vanes 44 surrounding an exterior periphery of the hub 32. When the impeller 40 rotates, air is drawn by the vanes 44 into the frame 10 through one of the lower surface and an upper surface of the frame 10 and expelled through the other of the lower surface and the upper surface of the frame 10.

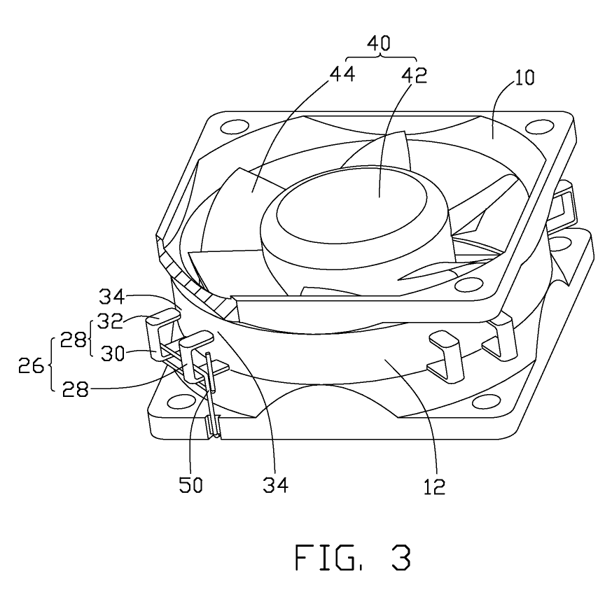

Referring also to FIG. 3, in use, if the length of the wire 50 is longer than a distance from a place, where the fan is to be set, to a desired plug connector, the excess portion of the wire 50 can be wound on one wire securing mechanism 26. The wire 50 is squeezed into the receiving spaces 36 via the corresponding gaps 34 of the hooks 28, and the wire 50 is wound onto the corresponding winding portions 30, until the excess portion of the wire 50 is satisfactorily secured. The wire 50 is capable of winding around the winding portions 30 of the two hooks 28 with a plurality of loops each encircling the two winding portions 30 therein. The stopping portions 32 of the hooks 28 and the smaller widths of the corresponding gaps 34 prevent the wound portion of the wire 50 from slipping off and/or unwinding.

With the excess portion of the wire 50 safely and neatly stored in the wire securing mechanism 26, the potential burning risk to the wire 50 is eliminated, and the inside of an electrical system, where the fan is disposed, is orderly.

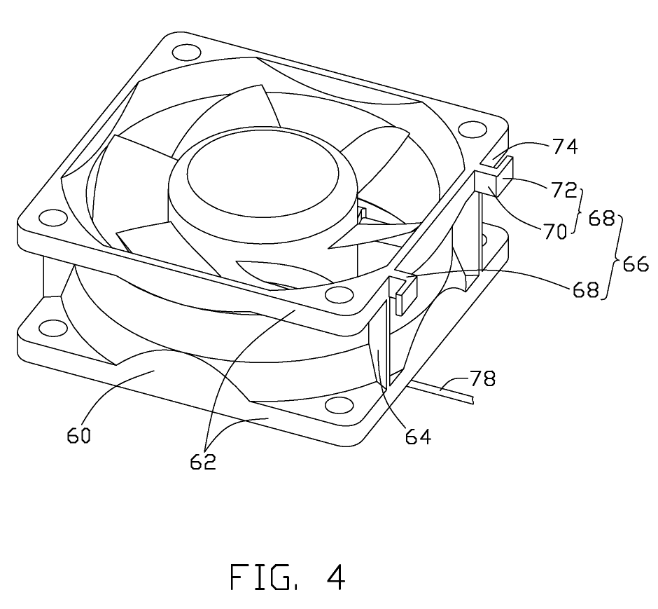

Referring to FIG. 4, in a second embodiment of the present invention, a reinforcing rib 64 is formed between every two opposite installing portions 62. A wire securing mechanism 66 having two hooks 68 is formed on an exterior frame 60 of a fan. Each hook 68 is generally L-shaped in profile. The two hooks 68 are set in a back-to-back configuration. Each hook 68 includes a winding portion 70 perpendicularly protruding out from an edge of the frame 60, and a stopping portion 72 perpendicularly bent from the winding portion 70. Each hook 68 and the edge of the frame 60 cooperatively define a receiving space 74. The wire 78 is wound onto the winding portions 70 through the corresponding receiving spaces 74 until an excess portion of the wire 78 is satisfactorily secured. The stopping portions 72 of the hooks 68 prevent the wound portion of the wire 78 from slipping off and/or unwinding. In addition, a couple of wire securing mechanisms 66 may be formed on the exterior frame 60 of the fan.

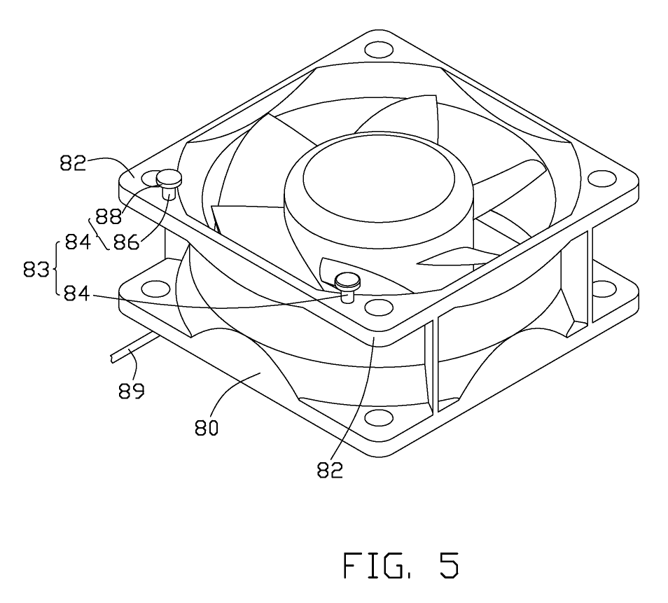

Referring to FIG. 5, in a third embodiment of the present invention, a wire securing mechanism 83 includes two hooks 84. Each hook 84 takes the form of a “T” that stands above one installing portion 82. Each hook 84 includes a winding post 86 (referred also to as a winding portion) extending from one installing portion 82, and a circular stopping end 88 (referred also to as a stopping portion) formed on the winding post 86. The wire 89 is wound onto the winding posts 86 of the hooks 68. Because diameters of the circular stopping ends 88 of the hooks 68 is greater than that of the corresponding winding posts 85, the circular stopping ends 88 prevent the wound portion of the wire 89 from slipping off and/or unwinding. In addition, a couple of wire securing mechanisms 83 may be formed on the exterior frame 80 of the fan.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A fan comprising:
an exterior frame;
a motor with an impeller disposed in the frame;
a wire electrically connected with the motor and reaching out of the frame; and
at least one wire securing mechanism comprising two spaced hooks formed on the frame to allow the wire winding around the hooks with a plurality of loops each encircling the hooks therein.

2. The fan as described in claim 1, wherein each of the hooks comprises a winding portion protruding out from a periphery of the frame to allow the wire winding therearound, and a stopping portion bent from the winding portion configured to prevent the wound portion of the wire from slipping off from the winding portion.

3. The fan as described in claim 2, wherein the winding portion is generally L-shaped in profile, and the stopping portion extends from the winding portion toward the frame.

4. The fan as described in claim 3, wherein a gap is defined between the frame and an end of the stopping portion.

5. The fan as described in claim 1, wherein each of the hooks is C-shaped in profile.

6. The fan as described in claim 5, wherein each of the hooks and the outside of the frame cooperatively define a receiving space configured for accommodating the wire.

7. The fan as described in claim 2, wherein each of the hooks is L-shaped in profile.

8. The fan as described in claim 7, wherein the hooks are set in a back-to-back configuration.

9. The fan as described in claim 8, wherein each of the hooks and an edge of the frame cooperatively define a receiving space configured for accommodating the wire.

10. The fan as described in claim 1, wherein each of the hooks is T-shaped in profile.

11. The fan as described in claim 10, wherein each of the hooks comprises a winding post extending from the frame, and a stopping end formed on the winding post, and a diameter of the stopping end is greater than a diameter of the winding post.

12. The fan as described in claim 1, wherein four first installing portions and four second installing portions protrude out from two opposite edges of the frame, respectively.

13. The fan as described in claim 12, wherein a recessed portion is formed between each of the first installing portions and one opposite second installing portion, and the at least one wire securing mechanism is set in the recessed portion.

14. The fan as described in claim 12, wherein an installing hole is defined in each of the installing portions configured for securing the fan.

15. A fan comprising:
a frame;
a wire securing mechanism protruding from the frame and comprising a pair of winding portions; and
a wire leading out from the fan for connecting with an external power source, the wire encircling the winding portions with at least one loop, for retaining an excess portion of the wire to the frame when a length of the wire is in excess of a distance from the fan to the external power source.

16. A fan comprising:
an exterior frame having opposite two parallel surfaces and a lateral surface connected between the two parallel surfaces;
a motor disposed in the frame between the two parallel surfaces and surrounded by the lateral surface;
a wire electrically connected with the motor and reaching out of the frame; and
at least one wire securing mechanism comprising two spaced hooks positioned at the lateral surface of the frame to allow the wire winding around the hooks with a plurality of loops each encircling the hooks therein.

17. The fan as claimed in claim 16, wherein each of the two hooks comprises a winding portion protruding out from the lateral surface of the frame to allow the wire winding therearound, and a stopping portion bent from the winding portion configured to prevent the wound portion of the wire from slipping off from the winding portion.
